(19) United States
(12) Patent Application Publication
(10) Pub. No.: US 2012/0130899 A1
(43) Pub. Date: May 24, 2012

(54) CHECK21 PROCESSING OF NON-DDA TRANSACTIONS

(76) Inventors: Patrick Shawn McMonagle, Boulder, CO (US); Rustin Ivins Carpenter, Acton, MA (US)

(21) Appl. No.: 13/160,244

(22) Filed: Jun. 14, 2011

Related U.S. Application Data
(60) Provisional application No. 61/415,044, filed on Nov. 18, 2010.

(51) Int. Cl. G06Q 40/00

(52) U.S. Cl. 705/45

(57) ABSTRACT

Embodiments provide processing of non-DDA transactions as Check21 transactions. In some implementations, a consumer registers a DDA account (e.g., a checking account) with a payment processing entity. The payment processing entity (e.g., or an agent or affiliate) generates a non-DDA account (e.g., a debit card account) and maps the new non-DDA account to the consumer's preexisting DDA account. When the consumer uses the non-DDA account at a point of sale, transaction information, including the non-DDA account information, is routed to the payment processing entity. The payment processing entity uses its mapping to identify the consumer's DDA account, uses the DDA account information and transaction information to generate a Check21-compliant check image, and clears and/or settles the transaction through Check21 channels. Accordingly, from the consumer's perspective, the transaction is carried out as a non-DDA transaction; while from the merchant's perspective, the transaction is processed using relatively low-cost Check21 channels.

### CROSS-REFERENCES

This applications claims priority from co-pending U.S. Provisional Patent Application No. 61/415,044, filed Nov. 18, 2010, entitled “REAL-TIME DEBIT AND CHECK21 FINANCIAL INSTRUMENT SYSTEM AND METHOD,” which is hereby incorporated by reference, as if set forth in full in this document, for all purposes.

### FIELD

Embodiments of the present invention relate generally to payment processing, and, more particularly, to processing of non-DDA transaction information through Check21 channels.

### BACKGROUND

Over the past decades, non-cash transactions have become ubiquitous. The vast majority of individual consumer transactions, business-to-business transactions, and other transactions for goods and services are effectuated using non-cash payment instruments, including credit cards, debit cards, and checks. This trend has been even further encouraged in recent years by the tremendous growth in e-commerce, including virtual storefronts, other virtual points of sale, and electronic payment capabilities of mobile devices (e.g., smart phones).

While consumers often consider various forms of payment to be largely interchangeable (e.g., differentiable mostly by the level of convenience associate with each), each form of payment can carry widely varying fees for the point of sale. For example, consumers may find debit cards to be much more convenient than checks, but a merchant may pay a significantly higher fee for accepting a debit card payment than for accepting a check payment. Accordingly, providers of goods and services desire payment options that carry relatively low processing fees, while being convenient for their customers.

### BRIEF SUMMARY

Among other things, embodiments described herein provide relatively inexpensive processing of non-DDA, consumer-facing transactions (e.g., debit card transactions at a point of sale) in accordance with the Check Clearing for the 21st Century Act (“Check21”). In some implementations, a consumer registers a DDA account (e.g., a checking account) with a payment processing entity. The payment processing entity (e.g., or an agent or affiliate) generates a non-DDA account (e.g., a debit card account) and maps the new non-DDA account to the consumer's preexisting DDA account. When the consumer uses the non-DDA account at a point of sale, transaction information, including the non-DDA account information, is routed to the payment processing entity. The payment processing entity uses its mapping to identify the consumer's DDA account, uses the DDA account information and transaction information to generate a Check21-compliant check image, and clears and/or settles the transaction through Check21 channels. Accordingly, from the consumer's perspective, the transaction is carried out as a non-DDA transaction; while from the merchant's perspective, the transaction is processed using relatively low-cost Check21 channels.

According to one set of embodiments, a method is provided for handling non-DDA transactions. The method includes: receiving non-DDA (e.g., debit) transaction information at a transaction processing system from a point of sale over a payment network, the non-DDA transaction information corresponding with a transaction between a consumer and the point of sale; identifying a DDA (e.g., checking) account with account information associated with the consumer according to a set of consumer mappings maintained by the transaction processing system, the consumer mappings generated as part of a consumer registration process that maps the DDA account of the consumer to a non-DDA transaction instrument; and generating a Check21-compliant check image from the account information of the DDA account and the non-DDA transaction information.

According to another set of embodiments, a transaction processing system is provided in communication with a plurality of points of sale over a payment network. The system includes: a mapping subsystem and an electronic DDA subsystem. The mapping subsystem is configured to: receive non-DDA transaction information from one of the points of sale over the payment network, the non-DDA transaction information corresponding with a transaction between a consumer and the point of sale; and identify a DDA account with account information associated with the consumer according to the non-DDA transaction information using a pre-defined consumer mapping. The electronic DDA subsystem is communicatively coupled with the mapping subsystem and configured to generate a Check21-compliant check image from the DDA account information and the non-DDA transaction information.

### BRIEF DESCRIPTION OF THE DRAWINGS

The present disclosure is described in conjunction with the appended figures:

FIG. 1 shows a simplified transaction environment, according to various embodiments.

FIG. 2 shows another embodiment of a transaction environment, similar to the one described with reference to FIG. 1.

FIG. 3 shows an illustrative flow diagram of a transaction environment having various payment network options, according to various embodiments.

FIG. 4A shows an illustrative partial transaction environment, according to various embodiments.

FIG. 4B shows another illustrative partial transaction environment, according to some embodiments.

FIG. 5 shows an illustrative computational system for implementing functionality of some embodiments.

FIG. 6 shows a flow diagram of an illustrative method for implementing a registration phase, according to various embodiments.

FIG. 7 shows a flow diagram of a method, including an illustrative transaction phase and validation phase, according to various embodiments.

FIG. 8 shows a flow diagram of an illustrative mapping phase method, according to various embodiments.

FIG. 9 shows a flow diagram of an illustrative method for communicating the Check21-compliant check images for clearing, according to various embodiments.

FIG. 10 shows a flow diagram of an illustrative clearing phase method, according to various embodiments.

In the appended figures, similar components and/or features may have the same reference label. Further, various components of the same type may be distinguished by following the reference label by a second label that distinguishes among the similar components. If only the first reference label is used in the specification, the description is applicable to any one of the similar components having the same first reference label irrespective of the second reference label.

### DETAILED DESCRIPTION

In the following description, numerous specific details are set forth to provide a thorough understanding of the present invention. However, one having ordinary skill in the art should recognize that the invention may be practiced without these specific details. In some instances, circuits, structures, and techniques have not been shown in detail to avoid obscuring the present invention.

Many different forms of non-cash payment instruments are available to consumers and merchants, including credit cards, debit cards, electronic fund transfers, and checks. Each is governed by a set of regulations that helps determine how transactions involving the payment instrument are handled, and each differs in convenience and/or cost to the consumer, convenience and/or cost to the merchant, infrastructure requirements, availability, etc. For example, using a payment card may be relatively convenient for a consumer, but relatively expensive for a merchant; while using a check may be relatively inconvenient for a consumer, but relatively inexpensive for a merchant.

Among other things, embodiments described herein provide relatively inexpensive processing of non-DDA, consumer-facing transactions (e.g., debit card transactions at a point of sale) in accordance with the Check Clearing for the 21st Century Act (“Check21”). In some implementations, a consumer registers a DDA account (e.g., a checking account) with a payment processing entity. The payment processing entity (e.g., or an agent or affiliate) generates a non-DDA account (e.g., a debit card account) and maps the new non-DDA account to the consumer's preexisting DDA account. When the consumer uses the non-DDA account at a point of sale, transaction information, including the non-DDA account information, is routed to the payment processing entity. The payment processing entity uses its mapping to identify the consumer's DDA account, uses the DDA account information and transaction information to generate a Check21-compliant check image, and clears and/or settles the transaction through Check21 channels. Accordingly, from the consumer's perspective, the transaction is carried out as a non-DDA transaction; while from the merchant's perspective, the transaction is processed using relatively low-cost Check21 channels.

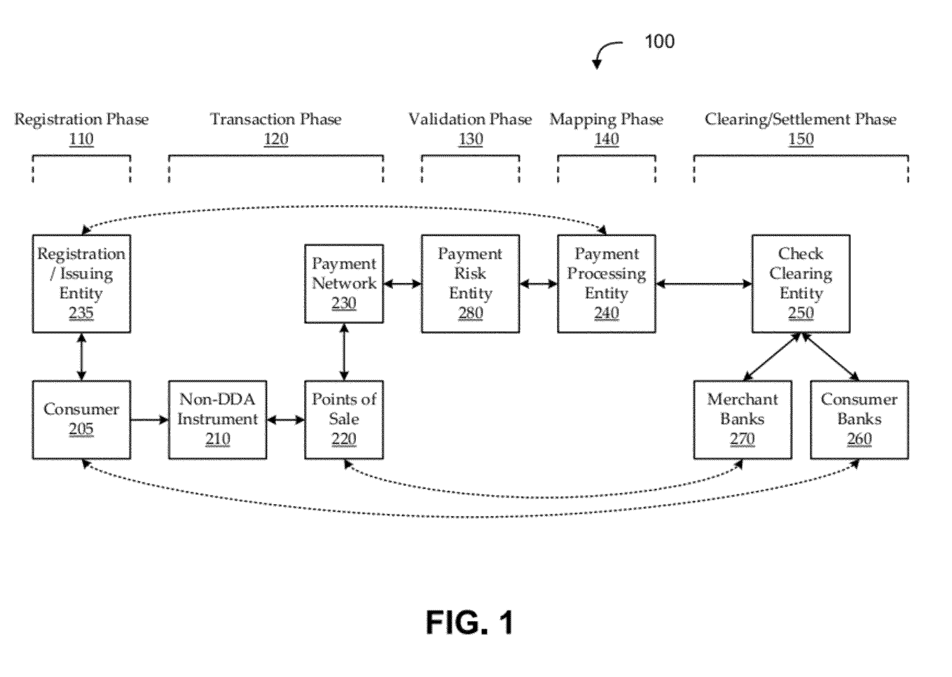

Turning first to FIG. 1, a simplified transaction environment 100 is shown. For the sake of clarity, the transaction environment 100 is segregated into a number of phases, including a registration phase 110, a transaction phase 120, a validation phase 130, a mapping phase 140, and a clearing phase 150. Each phase is illustrated with entities that may interact to facilitate that phase.

During the registration phase 110, a consumer 205 may register for a service facilitated by embodiments described herein. The consumer 205 registers an existing DDA (e.g., checking) account to be associated with a non-DDA transaction instrument 210. As will be described more fully below, the non-DDA transaction instrument 210 can be a physical transaction instrument (e.g., a debit card), a fully virtual transaction instrument (e.g., non-DDA instrument data stored in an electronic, PCI-compliant vault), a virtual transaction instrument tied to a physical device (e.g., a non-DDA instrument data stored in the SIM card of a mobile device and implemented through display and/or communications functionality of the mobile device), etc. Notably, embodiments of the non-DDA transaction instrument 210 include standard, non-DDA instrument information. For example, the non-DDA transaction instrument 210 can be a standard debit card with standard debit card information (e.g., standard debit account information stored on a magstripe, chip, etc.).

The service for which the consumer 205 is registering is provided by a payment processing entity 240. According to some embodiments, the consumer 205 registers for the service (e.g., online, at a physical location, over the phone, etc.) and is issued the non-DDA transaction instrument 210. The registration and/or issuing functionality may be facilitated through a registration/issuing entity 235, which may or may not be associated with the payment processing entity 240. For example, the registration/issuing entity 235 may be the same as, separate from, or an agent or affiliate of the payment processing entity 240.

As will be explained more fully below, embodiments of the registration phase 110 result in the consumer having a non-DDA transaction instrument 210 that can be used at a point of sale (POS) 220 (e.g., at a physical or virtual merchant location via a point of sale device or portal). Also, subsequent to the registration phase 110, the payment processing entity 240 maintains or has access to a mapping between the consumer's DDA account and the issued non-DDA transaction instrument 210. The non-DDA transaction instrument 210 can then be used in a transaction phase 120 to initiate a payment transaction.

Embodiments of the transaction phase 120 primarily involve the consumer 205 and the POS 220. As used herein, a consumer 205 may be any purchaser of goods and/or services, including, for example, an individual consumer, a corporate entity, an agent of an entity, etc. As used herein, a POS 220 generally refers to any individual or entity from which the goods or services are purchased by the consumer 205, including, for example, a physical storefront, a virtual storefront, an online auction or barter site, an individual seller, a retailer, a wholesaler, etc.

Typically, the transaction phase 120 includes the consumer 205 providing the non-DDA transaction instrument 210 to the POS 220 for purposes of carrying out a transaction. For example, this may involve swiping a debit card at a POS 220 terminal, using an online payment portal, etc. Transaction information, including non-DDA instrument information obtained from the non-DDA transaction instrument 210 (e.g., traditional debit card information, the date and value of the transaction, a transaction identifier, a POS 220 identifier, etc.) are communicated over a payment network 230. As used herein, a payment network 230 may include an open-loop network, a closed-loop network, the Internet, etc.

In a traditional non-DDA transaction, the non-DDA transaction information is communicated to an acquirer entity, which communicates with an issuer entity. The acquirer entity and issuer entity work together to validate and/or authorize the transaction. In some cases, additional entities are involved, including a card processor, a card association, etc. Depending on what type of payment network 230 is being used (e.g., open-loop versus closed-loop), different entities may act as the acquirer entity, issuer entity, card processor, card association, etc.

For example, the acquirer entity may receive the non-DDA transaction information and send it to a card association, which forwards the information to the issuer entity. The issuer entity approves or denies the transaction and sends a corresponding indication back to the acquirer entity (e.g., via the card association). The acquirer entity then responds accordingly to the POS 220 to complete the transaction.

Various embodiments use different entities in different ways. In general, embodiments that assign certain functionality to a specific entity are intended to be illustrative and should not be construed as limiting the scope of the embodiments. For example, in some embodiments, the non-DDA transaction information is communicated over the payment network 230 to the payment processing entity 240, which acts as the registration/issuing entity 235, the payment processing entity 240, and as a payment risk entity 280. In other embodiments, the payment processing entity 240 is in communication with the payment network 230 via the issuer (e.g., the registration/issuing entity 235), and the transaction is authorized by a separate payment risk entity 280. In certain embodiments, validation of the transaction is performed by the payment risk entity 280 in one or more validation phases 130. These and other embodiments are described more fully below.

Regardless of which type of payment network 230 is used or which, if any, validation phase 130 occurs, the non-DDA transaction information is received at the payment processing entity 240 for the mapping phase 140. As discussed above, a mapping is generated between a DDA account of the consumer 205 and the non-DDA transaction instrument 210, for example, at the registration phase 110. Upon receipt of the non-DDA transaction information, the payment processing entity 240 uses the mapping to identify the DDA account of the consumer 205 pre-associated with the non-DDA instrument information received as part of the non-DDA transaction information.

The non-DDA transaction information and the corresponding DDA account information can then be applied to one or more templates to generate an electronic check image. Embodiments generate the check image to be fully compliant with Check21 and associated regulations, effectively as a substitute check for the transaction. The mapping phase 140 results in a transaction that appears the same as if it had originated as a check transaction (using physical or electronic checking), which can then be cleared as a Check21 transaction in the clearing phase 150.

The clearing phase 150 involves clearing of the transaction according to Check21 channels. As used herein, “clearing” is intended to broadly include any steps used to complete the transaction after the mapping phase 140. For example, the clearing phase 150 can include clearing, settlement, etc.

The clearing and/or settlement of the transaction may typically involve a check clearing entity 250 (e.g., which could be the payment processing entity 240, an agent or affiliate thereof, or an unaffiliated third party), one or more consumer banks 260, and one or more merchant banks 270. As used herein, consumer banks 260 and merchant banks 270 are intended to indicate an association with a party to the transaction, and not any particular categorization of the type or function of the bank itself For example, the consumer 205 and POS 220 merchant may use the same banking entity, but that same entity would be considered the consumer bank 260 for part of the clearing phase 150 and the merchant bank 270 for another part of the clearing phase 150.

It is worth noting that clearing a transaction according to Check21 regulations is different from clearing according to non-DDA channels that would typically be used with a non-DDA transaction. For example, when a traditional credit-type of transaction is cleared, the non-DDA transaction is presented to the acquirer. The acquirer credits the merchant's account according to the transaction amount and typically informs the card association of the transaction. The card association debits the issuer's account and pays the acquirer. The issuer then posts the transaction to the consumer.

Traditional debit transactions are very similar, regardless of whether they are “signature” debit transactions, “PIN” debit transactions, “PIN-less” debit transactions, etc. Each type of transaction, however, tends to carry a different amount of risk and a different cost to the POS 220. For example, a credit-type of transaction may carry a 2% “discount rate” (also referred to as 200 basis points), meaning that the merchant is charged two dollars for each one-hundred dollar transaction. Debit transactions may be forty or fifty basis points lower (e.g., the merchant is charged $1.50 for a $100.00 transaction. Alternatively, some debit transactions (e.g., some PIN debit transactions) carry a fixed fee, like fifty cents for any transaction, regardless of the transaction amount.

DDA (e.g., check) clearing processes are different from non-DDA processes, like those discusses above. For the sake of illustration, a merchant periodically (e.g., daily) collects checks from its check transactions, and deposits them at its bank (sometimes referred to as the merchant bank, or Bank of First Deposit). The merchant bank combines those checks with other checks from other bank customers and sends them to its Federal Reserve District Bank (FRDB), which credits the merchant bank's Federal Reserve deposit account. In some cases, the merchant's bank temporarily credits the merchant's account while awaiting clearance of the transactions. The merchant's banks FRDB may send the checks to appropriate FRDB's in consumer bank districts, if necessary. The consumer bank's FRDB debits the consumer bank's Federal Reserve deposit account by the transaction amount (and other amounts of other batched transactions). Meanwhile, the physical check written by the consumer is sent from the merchant to the merchant bank, to the merchant bank's FRDB, to the consumer bank's FRDB, and finally to the consumer bank. When the check is received by the consumer bank, the consumer bank debits the consumer's DDA account.

Notably, considerable time (e.g., days) may be spent waiting for the physical check to transfer between banks. This time (or “float”) creates risk and can have other undesirable effects, like effects on the time-value of money. Thus, while the check clearing process is typically considerably cheaper to the merchant than non-DDA processes, merchants most contend with the float and other issues involved in check transactions.

In 2004, the U.S. Government passed Check21 to help reduce the dependence on paper checks by facilitating the use of electronic check images. Under Check21, compliant check images can be used as substitute checks, which can be processed with the same legal effect as paper checks. For example, the front and back sides of paper checks can be scanned to generate digital check image files (e.g., in Tagged Image File Format (TIFF)) that comply with Check21 regulations (e.g., according to the ANSI X9.180 final standard, sometimes referred to as generating the check images in “X9 format”). Because the electronic images can be transferred in seconds, rather than days, the float is largely eliminated. Accordingly, merchants can take advantage of inexpensive check processing, while avoiding some of the time-based limitations.

Still, taking full advantage of Check21 is difficult for a number of reasons. One reason is that consumers tend to consider checks as less convenient than non-DDA options. Another reason is that many merchants do not have check scanning systems and/or they do not otherwise desire to handle physical checks. Further, reasons having included security weaknesses (e.g., due to electronic transfer, due to scanned checks losing some of the security features built into the paper check instrument, etc.), inadvertent clearance of both the paper check and the check image (causing a double debit), trust issues (e.g., it may be considered too easy for a depositor to generate an image that looks like a valid check image and fraudulently present it to a bank as such), etc.

It is worth noting that Check21 is different from other types of electronic checking that use the Automated Clearing House (ACH) system. ACH has been around since the 1970's and has primarily been used for payroll, direct deposit, and other business-types of payments. For example, ACH transactions typically involve a pre-authorization by a “receiver” to allow an “originator” to originate the ACH transaction. The authorization may include the amount, date, etc.

While ACH includes electronic funds transfer and is often referred to as “electronic checking” or “e-checking,” it is appreciably different from the use of electronic check images under Check21. For the sake of illustration, the following describe some differences between typical ACH processes and typical Check21 processes. In one example, according to ACH, payments are sent to the merchant bank by ACH brokers; rather than being sent directly to the merchant bank from the consumer bank, as in Check21 (i.e., there may be no separate broker or third party that receives funds). In another example, ACH only allows processing of consumers that have pre-authorized the ACH processing, while Check21 allows processing of any consumer checks, even where the consumer has opted out of ACH processing. In yet another example, ACH processing typically only involves the Magnetic Ink Character Recognition (MICR) line data (including the account and routing numbers; while Check21 involves imaging of the front and back of the check, including MICR line data and other data that would be on the physical check instrument. Other differences include which types of disputes are allowed, windows during which those disputes can be made, and others.

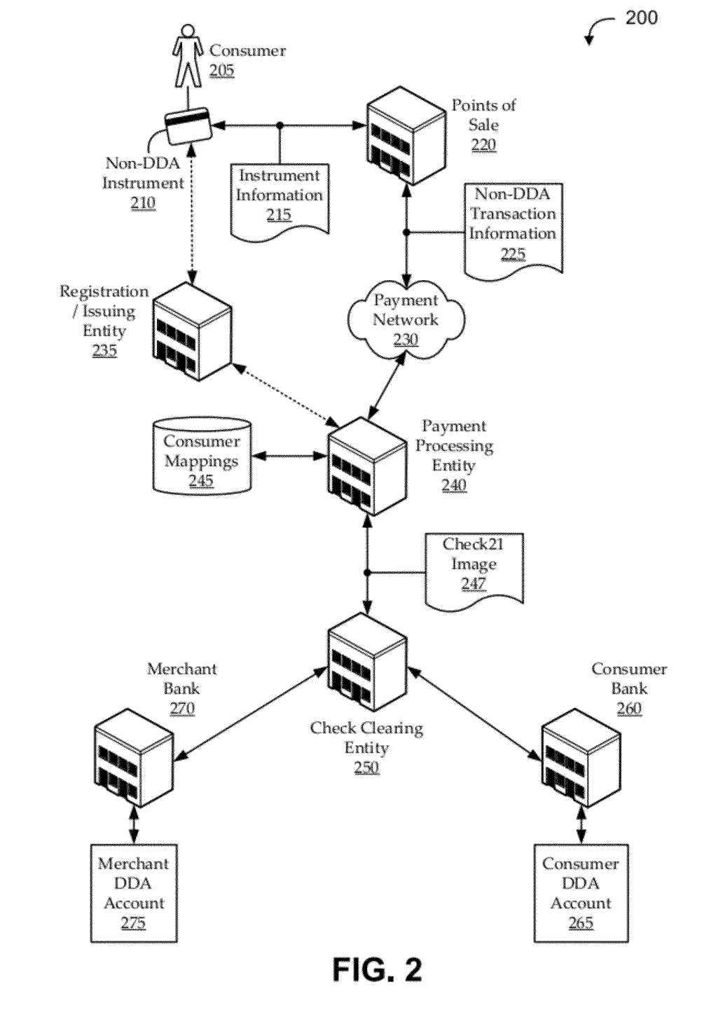

For the sake of illustration, FIG. 2 shows another embodiment of a transaction environment 200, similar to the one described with reference to FIG. 1. In an illustrative transaction, a consumer 205 uses a non-DDA transaction instrument 210 (e.g., a debit card) to purchase goods or services through a POS 220. As discussed above, the non-DDA transaction instrument 210 may have been issued by a registration/issuing entity 235 (e.g., as part of a registration phase 110). The non-DDA transaction instrument 210 includes non-DDA instrument information 215 (e.g., a debit account number, expiration date, etc.), which is communicated to the POS 220 (e.g., via a card reader, an electronic payment portal, etc.).

The non-DDA instrument information 215 is combined with other information relating to the transaction (e.g., time and date information, transaction amount, POS and/or merchant identifiers, etc.) to generate non-DDA transaction information 225. The non-DDA transaction information 225 is typically generated by the POS 220 and communicated over a payment network 230. As discussed above, different payment networks 230 are possible. However, for the sake of clarity, these differences are ignored in FIG. 2, and the non-DDA transaction information 225 is shown being communicated ultimately to the payment processing entity 240.

The payment processing entity 240 maintains consumer mappings 245 (e.g., generated as part of previous registration phases 110). The consumer mappings 245 include a mapping between the non-DDA instrument information 215 received as part of the non-DDA transaction information 225 and a DDA account of the consumer 205 that engaged in the transaction with the POS 220. The non-DDA transaction information 225 and the consumer mappings 245 are used by the payment processing entity 240 to generate a Check21-compliant check image 247.

Various types of Check21 data are used in various embodiments, including some or all of an Electronic Check Presentment (ECP) file (e.g., also called a Cash Letter), an Electronic Check Presentment with images (ECPi) file (e.g., also called an Image Cash Letter (ICL)), etc. Some of these and other types of data are defined, governed, or otherwise included in standards for certain Check21 processes, like the ANSI X9.37 standard. Further, some of these data are used in conjunction. For example, an ICL may include check images and corresponding transaction data. Accordingly, as used herein, references to check image files, including the Check21-compliant check image 247, are intended to broadly include any files or other data compliant for use in Check21 processing, and should not be construed as limiting the scope of embodiments to any one particular file or file type.

The Check21-compliant check image 247 is then cleared according to Check21 channels (e.g., as an electronic check through non-ACH channels). For example, a check clearing entity 250 facilitates the transfer of funds between a consumer banks 260 (i.e., the bank of the consumer 205) and a merchant bank 270 (i.e., the bank of the POS 220). Other functionality may be performed by the same or other entities that may or may not be illustrated by FIG. 2. For example, various types of authorization and/or validation may occur.

FIG. 2 effectively ignores which type of payment network 230 is used. Some embodiments, however, handle transactions differently according to which type of payment network 230 is selected. In some implementations, transactions with the non-DDA transaction instrument 210 are always processed with a particular type of payment network 230. In other implementations, the type of payment network 230 selected for the transaction is selected according to which type of transaction is occurring (e.g., where the non-DDA transaction instrument 210 is being used, who issued the non-DDA transaction instrument 210, and/or to which payment networks 230 the POS 220 is connected or affiliated, etc.).

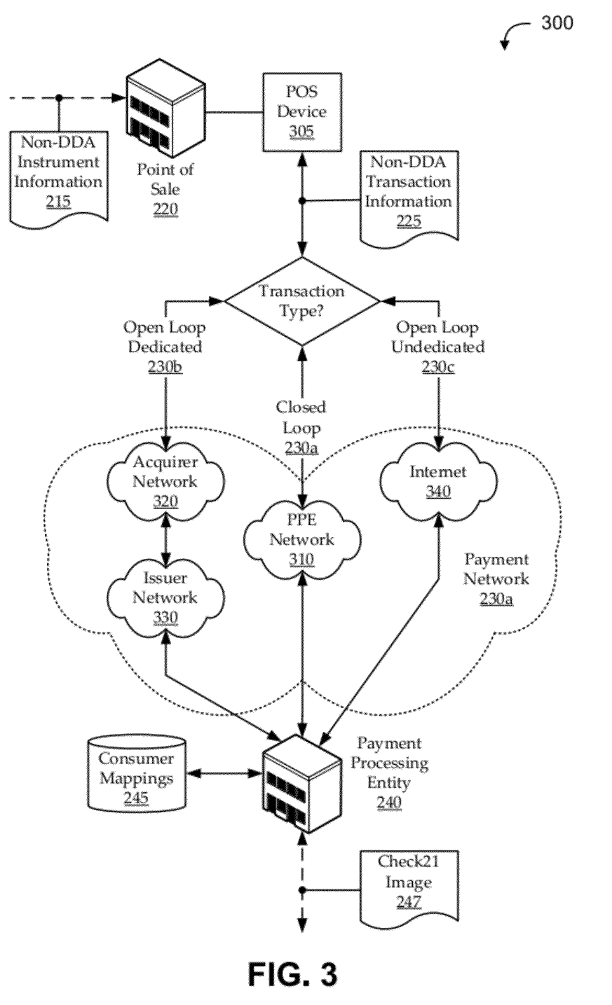

FIG. 3 shows an illustrative flow diagram of a transaction environment 300 having various payment network 230 options, according to various embodiments. The transaction environment 300 shows non-DDA instrument information 215 being received by the POS 220 via a POS device 305. The POS device 305 generates non-DDA transaction information 225, as discussed above.

A selection may then be made as to which payment network 230 to use according to which type of transaction has occurred. This determination may typically be made by the POS 220 (e.g., by the POS device 305). Three typical options are illustrated: a closed-loop payment network 230a, an open-loop dedicated payment network 230b, and an open-loop undedicated payment network 230c.

In a typical closed-loop payment network 230a, the network owner is the payment processing entity 240 and provides payment processing services to the consumer 205 and POS 220 without third-party intermediaries. For example, American Express and Discover both operate closed-loop payment networks 230a, such that they effectively act as both the issuer and the acquirer. Similarly, some merchants offer closed-loop payment cards for use only in the merchant's stores, where the merchant becomes the issuer of the card and the acquirer for payment processing. As illustrated in FIG. 3, the closed-loop payment network 230a is shown to communicate only through a payment processing entity network 310 to the payment processing entity 240. For example, the payment processing entity 240 controls the closed-loop payment network 230a.

By contrast, in an open loop network, two or more institutions communicate to process payments. For example, as shown, an open-loop dedicated payment network 230b includes an acquirer network 320 and an issuer network 330 that communicate transaction information to the payment processing entity 240. In various embodiments, the payment processing entity 240 is in communication with the issuer network 330 directly or via the payment processing entity network 310. Typical examples of open-loop dedicated payment networks 230b are implemented by Visa and Mastercard. A merchant or other entity (the issuer) issues the payment instruments, determines interest rates and fees, etc.; while another entity (the acquirer, which does not typically issue cads) determines merchant discount rates, etc. The issuer and acquirer communicate via the Visa or Mastercard network (i.e., the open-loop dedicated payment network 230b).

The third option, the open-loop undedicated payment network 230c, is like the open-loop dedicated payment network 230b at least because the merchant is not its own acquirer and issuer. However, a public network is used to facilitate payment processing. For example, payments are processed over the Internet, rather than through a dedicated payment network.

As discussed above, regardless of the type of payment network 230 used, the non-DDA transaction information 225 is received at the payment processing entity 240. The payment processing entity 240 can then map the information to the consumer's DDA information according to the consumer mappings 245 and generate a Check21-compliant check image 247 (e.g., generate an ICL, or generate the check image as part of the ICL, as discussed above) as part of a mapping phase 140. The transaction can then be cleared according to Check21 channels in a clearing phase 150.

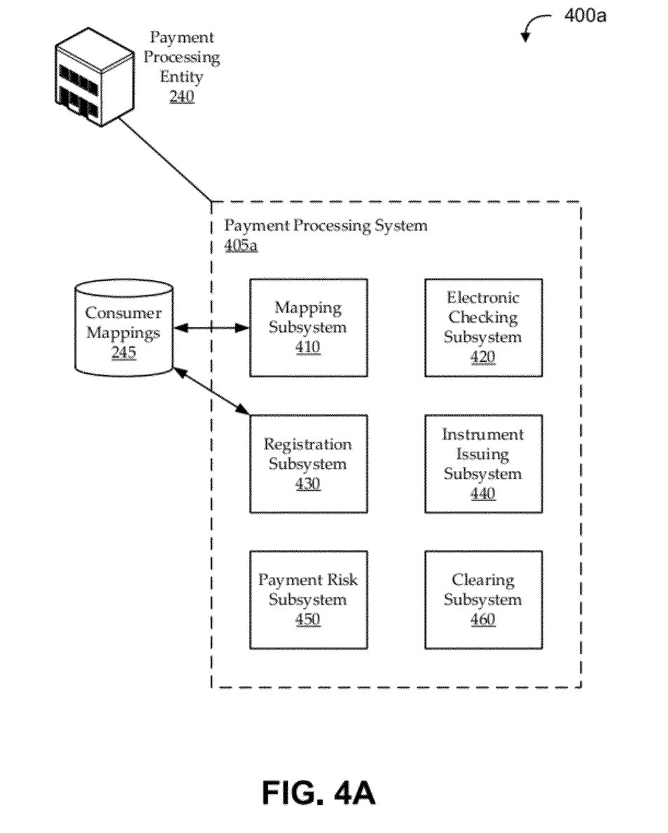

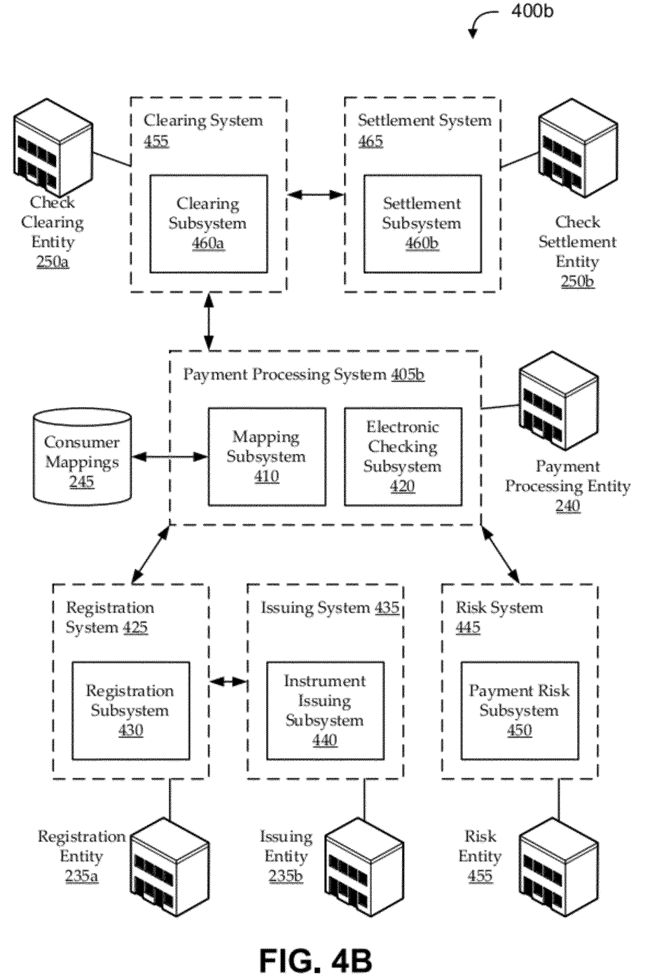

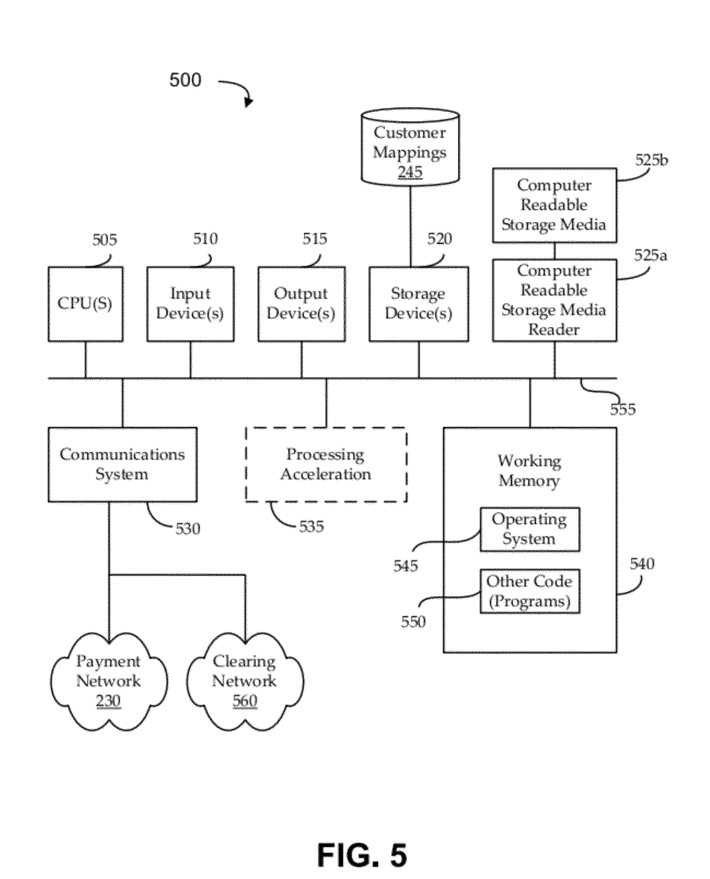

It will be appreciated from the above that the payment processing entity 240 can perform many different types of functionality, including functionality to facilitate some or all of the registration phase 110, the transaction phase 120, the validation phase 130, the mapping phase 140, and/or the clearing phase 150. Further, the payment processing entity 240 can be implemented as one or more systems in one or more locations controlled by or associated with one or more entities, etc. FIGS. 4A, 4B, and 5 show some illustrative payment processing entities 240, according to various embodiments.

Turning to FIG. 4A, an illustrative partial transaction environment 400a is shown, according to some embodiments. The partial transaction environment 400a includes a payment processing entity 240 that implements a payment processing system 405a. As illustrated, the payment processing system 405a includes a mapping subsystem 410, an electronic checking subsystem 420, a registration subsystem 430, an instrument issuing subsystem 440, a payment risk subsystem 450, and a clearing subsystem 460.

In the embodiment of FIG. 4A, the payment processing entity 240 implements functionality across the various phases of a transaction environment. For example, during the registration phase 110, the registration subsystem 430 engages with a consumer 205 and/or with another registration entity to register the consumer 205. Embodiments of the registration subsystem 430 receive and/or generate mapping information to store as part of consumer mappings 245. In various implementations, the registration subsystem 430 provides registration functionality via the phone (e.g., through interactive voice recognition systems, operators and/or registration professionals, etc.), via the Internet (e.g., via a web server, web portal, website, applet, application, etc.), or in any other useful way.

In some embodiments, the registration subsystem 430 is in communication with the instrument issuing subsystem 440. During the registration phase 110, the instrument issuing subsystem 440 may interface with the consumer 205 and/or other issuing entities to issue a non-DDA transaction instrument 210 to the consumer 205. As discussed above, the non-DDA transaction instrument 210 can be a physical instrument (e.g., a payment card, a key fob, etc.) or a virtual instrument (e.g., a set of non-DDA instrument information 215 stored in a secure location on a web server, mobile device, etc.). Depending on the type of non-DDA transaction instrument 210 issued to the consumer 205, issuing may be performed in different ways. For example, a physical instrument may be mailed to the consumer 205, while the consumer 205 may be given access to a virtual instrument by providing authentication information (e.g., a user name and password, PIN, etc.) along with an address (e.g., website, etc.) through which the information can be retrieved by a payment portal.

When a transaction occurs between the consumer 205 and a POS 220 (e.g., during a transaction phase 120), non-DDA transaction information 225 may be received by the mapping subsystem 410 (e.g., for a mapping phase 140). Non-DDA instrument information 215 from the non-DDA transaction information 225 is mapped by the mapping subsystem 410 to a consumer's DDA account according to the consumer mappings 245. In some implementations, before, during, and/or after the mapping phase 140, one or more validation phases 130 occur. This may be facilitated by the payment risk subsystem 450, which can handle various authorization and/or authentication functionality.

In some embodiments, during the mapping phase 140, the electronic checking subsystem 420 generates a Check21-compliant check image 247 from the non-DDA transaction information 225, the consumer mappings 245, and/or templates or other information. As discussed above, the generation of the Check21-compliant check image 247 may involve generation of a standard image format (e.g., a TIFF image) according to pre-negotiated rules (e.g., one or more ANSI standards) to look like a scan image of a front and back side of a physical check.

In some embodiments, the electronic checking subsystem 420 includes functionality to print a physical check. For example, it may be desirable in some instances to print a physical check and scan the physical check to generate the Check21-compliant check image 247. In other instances, printing the physical check can be useful in generation of substitute check instruments, customer service, etc. Some embodiments of the electronic checking subsystem 420 interface with one or more other systems or entities to facilitate the electronic checking functionality. For example, other systems may provide check templates with different types of watermarks or images for the check images, check register functionality, electronic signature processing, etc.

Having generated the electronic check images, one or more can be cleared during a clearing phase 150. All or part of the clearing phase 150 can be facilitated by the clearing subsystem 460. In some embodiments, the clearing subsystem 460 interfaces with one or more check clearinghouses or other Check21 clearing channels. In other embodiments, the clearing subsystem 460 performs various clearing functions, including one or more of authenticating checking information, clearing the transactions, settling the transactions, etc. Embodiments of the clearing subsystem 460 also perform optimization functionality, including batching and sorting the check images as described more fully below.

The functionality of the various subsystems of the payment processing system 405a are illustrated in FIG. 4A as part of a single payment processing entity 240. It will be appreciated that many other types of implementations are possible. For example, some or all of the various subsystems can be spread across various entities in various locations.

FIG. 4B shows another illustrative partial transaction environment 400b, according to some embodiments. As in FIG. 4A, the partial transaction environment 400b includes a mapping subsystem 410, an electronic checking subsystem 420, a registration subsystem 430, an instrument issuing subsystem 440, a payment risk subsystem 450, and a clearing subsystem 460. Unlike FIG. 4A, the partial transaction environment 400b of FIG. 4B illustrates one way by which the subsystems can be spread across multiple systems and implemented by various entities.

In particular, the payment processing entity 240 still implements a payment processing system 405b, but the payment processing system 405b includes only the mapping subsystem 410 (e.g., which may maintain the consumer mappings 245) and the electronic checking subsystem 420. Registration is handled by a registration entity 235a that implements a registration system 425 including the registration subsystem 430. Instrument issuing is handled by an issuing entity 235b that implements an issuing system 435 including the instrument issuing subsystem 440. Risk management is handled by a risk entity 455 that implements a risk system 445 including the payment risk subsystem 450. Check clearing is handled by a check clearing entity 250a that implements a clearing system 425 including the clearing subsystem 460a. And check settlement is handled by a settlement entity 250b that implements a settlement system 465 including the settlement subsystem 460b.

Some or all of the systems, subsystems, components, etc. can be implemented by one or more computational systems. For the sake of illustration, FIG. 5 shows an illustrative computational system 500 for implementing functionality of some embodiments. The computational system 500 is shown having hardware elements that may be electrically coupled via a bus 555 (or may otherwise be in communication, as appropriate). The hardware elements may include one or more processors 505, including without limitation one or more general-purpose processors and/or one or more special-purpose processors (such as digital signal processing chips, graphics acceleration chips, and/or the like); one or more input devices 510, which can include without limitation a mouse, a keyboard, and/or the like; and one or more output devices 515, which can include without limitation a display device, a printer, and/or the like.

The computational system 500 may further include (and/or be in communication with) one or more storage devices 520, which can comprise, without limitation, local and/or network accessible storage and/or can include, without limitation, a disk drive, a drive array, an optical storage device, a solid-state storage device such as a random access memory (“RAM”), and/or a read-only memory (“ROM”), which can be programmable, flash-updateable, and/or the like. Embodiments of the storage devices 520 may maintain storage of consumer mappings 245, Check21-compliant check images 247, and/or other data used to provide functionality of various embodiments.

The computational system 500 may also include a communications system 530, which can include without limitation a modem, a network card (wireless or wired), an infra-red communication device, a wireless communication device and/or chipset (such as a Bluetooth device, an 802.11 device, a WiMAX device, cellular communication facilities, etc.), and/or the like. The communications system 530 may permit data to be exchanged with one or more networks, including any networks or devices described herein. For example, the communications system 530 may facilitate communications with one or more payment networks 230, check clearing networks 560, etc.

In many embodiments, the computational system 500 will further comprise a working memory 540, which can include a RAM or ROM device. Various software elements are illustrated as being currently located within the working memory 540, including an operating system 545 and/or other code, such as one or more application programs 550, which may include computer programs of the invention, and/or may be designed to implement methods of the invention and/or configure systems of the invention, as described herein. For example, mapping of non-DDA instrument information 215 to consumer DDA information according to the consumer mappings 245, generation of Check21-compliant check images 247, and/or other functionality may be implemented through applications 550 running on the computational system 500 via the working memory 540.

Merely by way of example, functionality of one or more systems, components, or procedures described herein might be implemented as code and/or instructions executable by a computer (and/or a processor within a computer). A set of these instructions and/or code might be stored on a computer readable storage medium 525b. In some embodiments, the computer readable storage medium 525b is the storage device(s) 520 described above. In other embodiments, the computer readable storage medium 525b might be incorporated within a computational system, such as the system 500.

In still other embodiments, the computer readable storage medium 525b might be separate from the computational system 500 (i.e., a removable medium, such as a compact disc, etc.), and/or provided in an installation package, such that the storage medium can be used to configure a general purpose computer with the instructions/code stored thereon. These instructions might take the form of executable code, which is executable by the computational system 500 and/or might take the form of source and/or installable code, which, upon compilation and/or installation on the computational system 500 (e.g., using any of a variety of generally available compilers, installation programs, compression/decompression utilities, etc.), then takes the form of executable code. In these embodiments, the computer readable storage medium 525b may be read by a computer readable storage media reader 525a.

In one embodiment, the invention employs the computational system to perform functionality of embodiments of the invention. According to a set of embodiments, some or all of the functions are performed by the computational system 500 in response to processor 505 executing one or more sequences of one or more instructions (which might be incorporated into the operating system 545 and/or other code, such as an application program 550) contained in the working memory 540. Such instructions may be read into the working memory 540 from another machine-readable medium, such as one or more of the storage device(s) 520. Merely by way of example, execution of the sequences of instructions contained in the working memory 540 might cause the processor(s) 505 to perform one or more procedures of the methods described herein. In this way, the computational system 500 can be “configured to” or “operable to” perform any number of such procedures or methods.

It is worth noting that the terms “machine readable medium ” and “computer readable medium,” as used herein, refer to any medium that participates in providing data that causes a machine to operate in a specific fashion. In an embodiment implemented using the computational system 500, various machine-readable media might be involved in providing instructions/code to processor(s) 505 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical or magnetic disks, such as the storage device(s) 520. Volatile media includes, without limitation, dynamic memory, such as the working memory 540. Transmission media includes coaxial cables, copper wire, and fiber optics, including the wires that comprise the bus 555, as well as the various components of the communications system 530 (and/or the media by which the communications system 530 provides communication with other devices).

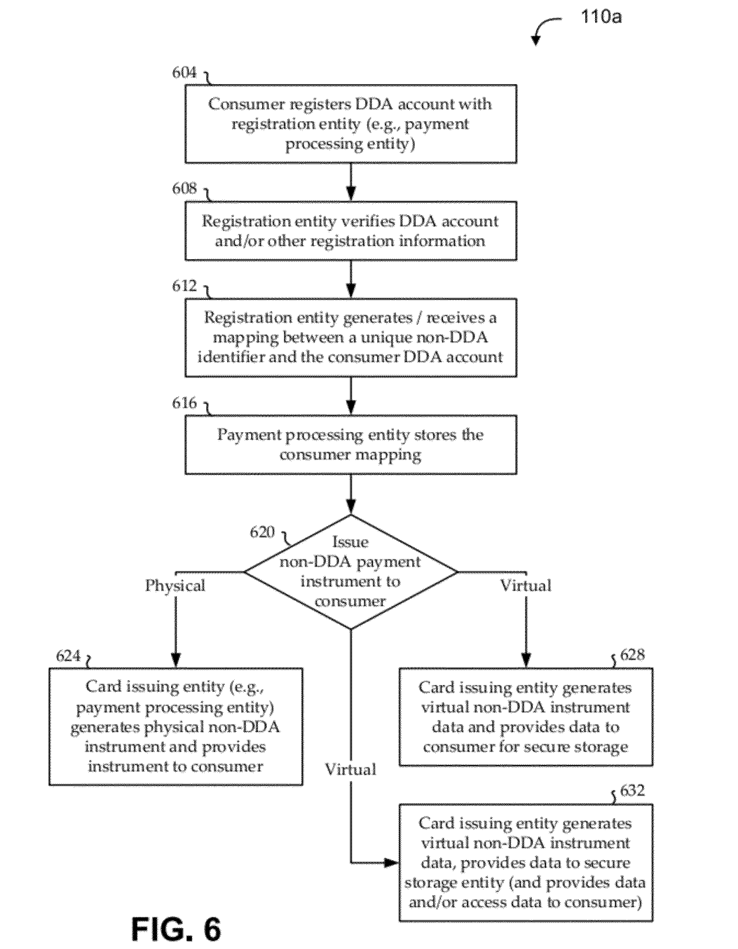

The various systems and environments described above with reference to FIGS. 1-5 can be configured to perform various method embodiments described below with reference to FIGS. 6-10. Embodiments of the methods may alternatively be performed using other system configurations and/or in other environments. Accordingly, functionality described with reference to particular subsystems, components, entities, etc. is intended for the sake of clarity only and should not be construed as limiting the scope of those embodiments.

Turning to FIG. 6, a flow diagram is shown of an illustrative method 110a for implementing a registration phase, according to various embodiments. The method 110a begins at block 604 when a consumer 205 registers a DDA account with a registration entity. As discussed above, the consumer 205 may access an online registration system, register in person at a banking location, etc. The consumer 205 submits financial and personal information, for example, in the form of an application via Mail, Fax, Telephone, Internet or Mobile Web.

According to some embodiments, registration includes industry standard payment instrument processes, such as completion of a pre-printed form and mailing that form, calling a telephone number, speaking to a customer service agent, visiting an internet site provided for a payment instrument and completing a form via the website, etc. Regardless of which of these or other industry standard methods may be utilized in subscribing for a payment instrument the consumer 205 may supply personal and banking information that will be used to facilitate purchases using the payment instrument. This information may include name, address, social security number, drivers' license number and banking information. Specifically for banking information the routing and transit number (RTN) for their bank and the account number may be supplied.

At block 608, the registration entity verifies the DDA account information, identification information, etc. to validate the registration. For example, the registration entity may approve or decline the application. In some embodiments, information supplied by the consumer during the application process is processed by an application processing entity. The application processing entity may or may not be part of (or affiliated with) the registration entity, and the registration entity may or may not be part of (or affiliated with) a payment processing entity. The application processing entity may review and validate the data provided by the consumer according to block 608. In some cases, fraud or identity theft processing may be executed during this step using existing industry standard processes. Some or all of the data collected at block 608 may be added to an applicant information data file. The data files may be kept secure within an application processing entity data processing facility using encryption and/or other techniques to provide confidentiality. At one or more times during a calendar day or periodically, the data collected in the data files can be transferred to other entities, as needed.

The data files may be used to validate application information (e.g., banking account information) supplied by the applicant. This validation may be accomplished by either submitting a request to a payment risk entity (e.g., payment risk entity 280), to the consumer's bank (e.g., consumer bank 260), etc. Different techniques for validation are available. For example, the registration and/or application processing entity can deposit monies into the consumer's account; and, if the deposit is successful, validate the banking information.

Having verified the registration information, the registration entity generates (e.g., or receives from another entity) a mapping between the consumer's DDA account and a non-DDA identifier at block 612. For example, various registries are available that can generate unique non-DDA identifiers. The identifiers may include any information that may typically be generated as part of issuing a non-DDA payment instrument (e.g., the information that would be embossed or printed on a debit card, stored on a magstripe, etc.). In some cases, the information includes a debit card number, an expiration date, etc.

At block 616, a payment processing entity 240 receives the mapping from the registration entity (e.g., unless the payment processing entity 240 generates the mapping itself) and stores the mapping in a consumer mappings 245 storage. For example, the consumer mappings 245 can be stored at one or more servers, in a database, etc. Embodiments store the consumer mappings 245 using techniques that allow for optimized correlation between received non-DDA identifiers (e.g., non-DDA instrument information 215 received as part of non-DDA transaction information 225) and consumer DDA accounts. Further, embodiments store and or communicate the consumer mappings 245 using techniques to provide physical and/or logical data security.

At block 620, a payment instrument (e.g., non-DDA transaction instrument 210) is issued to the consumer 205. As discussed above, the payment instrument may be a physical or logical payment instrument, and may be issued in various ways. In some embodiments, a physical instrument is issued at block 624. For example, the consumer 205 may be issued a debit card via mail. In some embodiments, instruments may be branded, associated with one or more merchants, associated with one or more payment networks, etc. For example, merchants may incentivize consumers to apply for a debit card branded by the merchant.

In other embodiments, a virtual payment instrument is issued at block 628. Virtual non-DDA instrument information is generated, and some or all of the information is provided to the consumer 205 for storage in a secure location. For example, the consumer may store the data in an electronic wallet application on a personal computer, at an Internet location, etc. In certain embodiments, the data is stored at a consumer's mobile device. For example, the data can be stored on a subscriber identity module (SIM) card, or other similar storage device. Alternatively, the consumer 205 may have or may be provided with a device configured to securely store the information (e.g., which may act effectively like a physical instrument), like a smart card, etc.

In still other embodiments, a virtual payment instrument is issued at block 632 by generating virtual non-DDA instrument information, and providing the information to a storage entity. For example, the instrument information can be stored in a payment card industry (PCI) compliant virtual vault or other secure location. The secure storage location can be affiliated or unaffiliated with the payment processing entity 240. Various embodiments facilitate usage of the information by the consumer 205 in different ways. For example, during a purchase transaction through a web-based payment portal, an option may be provided to pay using a stored non-DDA account. Alternatively, the account may be associated with identifiers (e.g., a virtual debit card number and expiration date, a user identifier and password, etc.) that allow usage of the information for payment as if the consumer has a physical payment instrument.

In some implementations, the consumer 205 must perform additional steps to activate and/or authorize the payment instrument prior to use. For example, the consumer 205 may call a number, respond to an email, follow an Internet link via an email, access a website, etc. to activate the payment instrument. When the registration phase 110 is complete, the payment instrument is ready for use by the consumer 205 in one or more transaction phases 120.

It is worth noting that the consumer 205 may be denied registration. For example, application details may not be validated, the account may be found to be invalid or insufficiently funded, the application may be deemed otherwise too risky or suspect, etc. In the event of a denial, embodiments include a mechanism for informing the consumer 205 of the denial. For example, the consumer 205 may receive a letter or email indicating that the application was denied.

Further, some embodiments of the registration process may include additional functionality that may be desirable to certain consumers. For example, the registration process may allow the customer to provide a specimen of an authorized signature, preferred background images for generated check images, preferred background images for a physical payment instrument, associations with loyalty programs, etc.

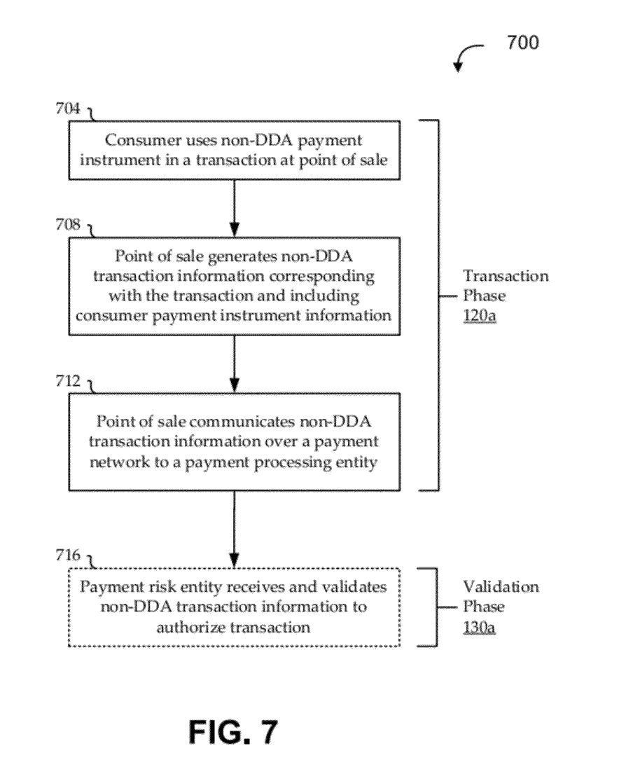

FIG. 7 shows a flow diagram of a method 700, including an illustrative transaction phase 120a and validation phase 130a, according to various embodiments. The method 700 begins with a transaction phase 120a. At block 704, a consumer 205 uses a non-DDA transaction instrument (e.g., the non-DDA transaction instrument 210 issued as part of the registration phase 110) at a POS 220. As discussed above, the POS 220 is intended to broadly include anything through which the consumer 205 can engage in the transaction. For example, the POS 220 can include a physical POS device (e.g., the POS device 305 shown in FIG. 3), an Internet payment portal, a mobile device configured to accept payments, etc.

It is worth noting that different types of payment instruments can be used by the customer 205 at the POS 220 in different ways. In one set of examples, physical payment instruments can include standard magstripes, RFID chips, etc., configured to interface with one or more different types of POS devices. In another set of examples, mobile devices (e.g., smart phones) can provide non-DDA instrument information via display (e.g., as a barcode, set of displayed alphanumeric or other symbols, etc.), optical interface, short-range or long-range communications interface, physical or logical ports, acoustical patterns, etc.

At block 708, the POS 220 generates non-DDA transaction information (e.g., non-DDA transaction information 225). The transaction information corresponds with non-DDA instrument information 215 received from the non-DDA transaction instrument 210 and includes additional information about the transaction. For example, the non-DDA transaction information 225 includes a transaction date and/or time, POS 220 (and/or merchant) identifier, transaction amount, etc. In some embodiments, additional information is provided, such as a type of transaction. For example, identification of a type of goods or services can be used by one or more entities to develop demographics information, to handle rewards points or other program affiliation information, to categorize spending for health savings accounts or bookkeeping purposes, etc.

At block 712, the POS 220 communicates the non-DDA transaction information 225 over a payment network 230 to a payment processing entity 240. As described above with reference to FIG. 3, different types of payment networks 230 may be used, for example according to the type of transaction. Further, the payment network 230 may include any type of physical and/or logical architecture, including local- and/or wide-area networks, dedicated networks, public and/or private networks, secure networks, wired and/or wireless networks, cellular networks, etc. Further (e.g., as illustrated in FIG. 3), the payment network 230 may include sub-networks, such as networks controlled by acquirers, issuers, etc.

In some embodiments, one or more validation phases 130 also occur before, during, and/or after the transaction phase 120a. An embodiment of a validation phase 130a is illustrated as including block 716, in which a payment risk entity receives and validates the non-DDA transaction information 225 to authorize the transaction. For example, the transaction request may be subject to a risk management authorization process, which may involve generating a credit score (e.g., including making an instantaneous credit check, examining past transactions, etc.) to decide whether to pass the non-DDA transaction information 225 on to the payment processing entity 240. In some embodiments, the payment risk entity can advance money to the merchant, optionally, less a transaction fee. For example, if there end up being insufficient funds in the consumer's DDA account, the payment risk entity may own the associated debt and may take steps to collect on it. In some other embodiments, the transaction will not be subject to a risk management authorization process. For example, the funds may be considered “good funds” (e.g., where the funds have been received by the merchant prior to delivery of the goods or services by the merchant).

As will be explained more fully below, multiple validation phases 130 may be used for different purposes. Embodiments of the validation phase 130a of FIG. 7 are used to authorize the non-DDA transaction prior to any type of mapping to the DDA account of the consumer 205. For example, a payment transaction made using a debit card can be validated as a typical debit transaction (e.g., using risk profiling, fraud mitigation, and/or other techniques) without regard for any mapping between the non-DDA transaction instrument 210 used in the transaction and any other consumer mappings 245 information. By contrast, further validation may occur subsequent to mapping to see, for example, if the associated DDA account has sufficient funds, etc.

It is worth noting that the validation phase 130a may occur prior to communicating the non-DDA transaction information 225 over the payment network 230 at block 712. In fact, if the transaction is determined to be invalid at block 716, the transaction may be denied at the POS 220 without communicating the non-DDA transaction information 225 to the payment processing entity 240. Alternatively, even if the transaction is not validated at block 716, the payment processing entity 240 may receive data indicating that the transaction failed the validation phase 130a. This information may be used, for example, for purposes of risk profiling, quality assurance, customer service, etc.

For example, in a typical debit transaction, the consumer 205 uses the debit card (i.e., the non-DDA transaction instrument 210) at a POS 220 (e.g., by swiping the card at a terminal). The terminal generates non-DDA transaction information 225 and sends the information to a merchant acquirer (e.g., the bank providing payment processing services to the merchant). The information is then forwarded over the payment network 230 to an issuer. In some embodiments, the issuer is (or is affiliated with) the payment processing entity 240. The issuer may attempt to authorize (or pre-authorize, as explained below) the transaction, for example, by looking at whether the non-DDA account is in good standing. The issuer may then send an authorization code back to the acquirer, which sends the merchant an indication that the transaction has been authorized.

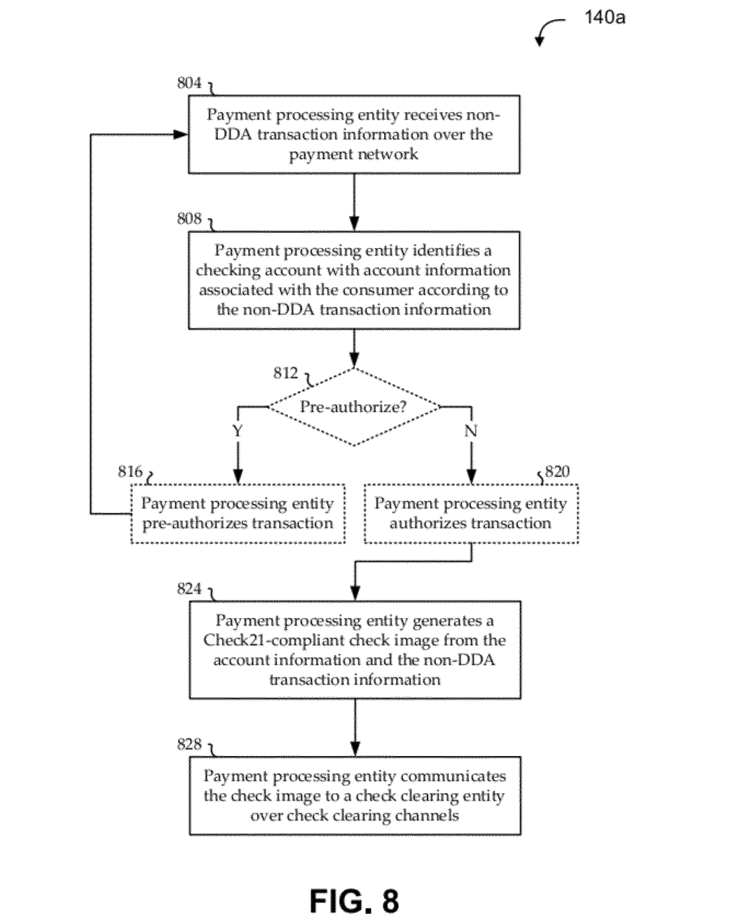

Once the non-DDA transaction information 225 is communicated over the payment network 230 to the payment processing entity 240, the mapping phase 140 may commence. FIG. 8 shows a flow diagram of an illustrative mapping phase method 140a, according to various embodiments. The method 140a begins when the payment processing entity 240 receives the non-DDA transaction information 225 via the payment network 230 at block 804.

At block 808, the payment processing entity 240 identifies consumer DDA account information corresponding with the non-DDA transaction information 225 according to the consumer mappings 245. For example, the payment processing entity 240 extracts non-DDA instrument information 215 from the received information and queries the consumer mappings 245 against the extracted non-DDA instrument information 215. Some embodiments use a simple database lookup, while other embodiments include more complex data processing and/or mining techniques (e.g., hashing, encryption, validation, parsing, filtering, etc.).

In many typical transactions, it is desirable to pre-authorize the transaction, as when a consumer 205 is supplied with goods and/or services prior to final authorization of payment. In one example, a consumer 205 swipes a credit or debit card at a gas station pump prior to pumping gasoline. The card may be pre-authorized prior to allowing the consumer to begin pumping. After finishing pumping the gasoline, the funal transaction amount is known, and the card can be fully authorized and charged. Other examples may include when a hotel pre-authorizes a card upon check-in, when a bar pre-authorizes a card to open a tab, when a restaurant pre-authorizes a card prior to finalizing the total with tip, etc. In these and/or other scenarios, at block 812, a determination is made as to whether to pre-authorize the transaction.

If a determination is made to pre-authorize the transaction, the payment processing entity 240 pre-authorizes the transaction at block 816. For example, the payment processing entity 240 may perform a risk assessment, pre-authorize a higher transaction amount, pre-authorize the actual transaction amount, etc. The payment processing entity 240 then sends a pre-authorization determination back to the merchant. In some embodiments, the payment processing entity 240 acts as the issuer and sends the pre-authorization over a payment network 230 to the merchant via the merchant acquirer. If the transaction fails the pre-authorization at block 816, an indication may be communicated back to the merchant that the transaction is not pre-authorized.

If the transaction passes the pre-authorization at block 816, the non-DDA transaction information 225 may be received again at block 804 for full authorization. For example, the customer 205 may accept payment after the pre-authorization, causing the transaction to continue with a full authorization. The non-DDA transaction information 225 is then mapped again at block 808 to determine the corresponding consumer DDA information. In some embodiments, the mapping only occurs during the authorization (i.e., not during the pre-authorization) portion of the method 140a. In other embodiments, the transaction is flagged with a transaction identifier to help associate the transaction during pre-authorization with the same transaction during full authorization.

If a determination is made at block 812 not to pre-authorize the transaction, or if the transaction has previously been pre-authorized, the method 140a may continue with block 820 by fully authorizing the transaction. The full authorization may involve the same, similar, or different steps from those of a pre-authorization. For example, a determination may be made that sufficient funds are available in the consumer's DDA account or that the consumer is in good standing.

In some embodiments, the payment processing entity 240 provides one or more levels of risk assessment for use in one or more authorization steps. One level may include periodically performing risk profiling against the consumer's account (e.g., the DDA account and/or the associated non-DDA account, and possibly against additional accounts or factors). Another level may involve periodically making small deposits and/or withdrawals from the consumer's DDA account to check that the DDA account remains valid and/or that sufficient funds exist. Yet another level may involve performing the risk profiling and/or the deposit/withdrawal substantially at the time of the transaction. The payment processing entity 240 can provide any or all of these or other techniques, and may charge the merchant or the consumer accordingly. For example, a merchant engaging in large numbers of risky transactions may desire to pay a higher fee to the payment processing entity 240 to perform a more thorough risk assessment at the time of each transaction. The fee may be charged, for example, as part of an interchange fee between the merchant acquirer and the payment processing entity 240.

In one illustrative case, a consumer 205 swipes a debit card at a POS 220. The POS 220 sends the non-DDA transaction information 225 to the merchant acquirer, which forwards the non-DDA transaction information 225 to the payment processing entity 240 for pre-authorization. The payment processing entity 240 maps the non-DDA instrument information 215 to see if there is a valid associated DDA account for the consumer 205 (e.g., and if the account is in good standing, etc.). If the transaction is pre-authorized, the consumer 205 receives an indication at the POS 220 to “accept” the payment, and/or sign for the transaction, etc. Having approved the transaction for the transaction amount, the transaction can then be fully authorized. Accordingly, the POS 220 again sends the non-DDA transaction information 225 to the merchant acquirer, which forwards the non-DDA transaction information 225 to the payment processing entity 240 for full authorization.

Periodically (e.g., daily, four times per day, etc.), the merchant may batch the transactions of the day, and communicate those transactions to the merchant acquirer by sending all the corresponding non-DDA transaction information 225. The merchant acquirer routes the information to the appropriate issuers (e.g., the payment processing entity 240) over appropriate payment networks 230 (e.g., via closed-loop and/or open loop networks, depending on the transaction type). The issuer and the payment network charge an interchange fee to cover risk and processing services, etc. The acquirer may then charge an additional transaction fee, or “discount rate,” for processing the transaction.

For example, a consumer 205 engages in a one-hundred dollar transaction at a POS 220. The issuer and the payment network may charge an interchange fee of two dollars (two-hundred basis points), and the acquirer may then charge an additional discount rate of fifty cents (fifty basis points). The consumer is ultimately billed the one-hundred dollars for the transaction, and the merchant ultimately receives $97.50 for the transaction (i.e., the merchant is charged 250 basis points for the transaction).

It is worth noting that the majority of the cost to the merchant typically comes from the interchange fee (e.g., and/or related fees of the issuer and/or payment network). In the case of a typical non-DDA transaction, these fees tend to be relatively high because of higher risk and higher processing costs. Typical DDA transactions tend to carry relatively low risk and relatively low processing costs. Accordingly, by processing the non-DDA transaction as a DDA (Check21) transaction, it is possible to appreciably reduce interchange and/or related fees.

At block 824, the payment processing entity 240 generates a Check21-compliant check image 247 from the non-DDA transaction information 225 and the consumer mappings 245 information. As discussed above, templates, standards, and/or other information can be used to generate the image. According to Check21 regulations, the image is effectively the image of a front side and a back side of a compliant check instrument. The check instrument may include fields that are automatically filled in with the appropriate information, and some or all of the fields may be mandatory.

For example, a front-side check template may include fields for the consumer bank routing number, the consumer's DDA account number, the consumer's name and address, the transaction amount in numbers, the transaction amount in words, the transaction date, a consumer signature (or proxy), a transaction description, etc. A back-side template may include an endorsement area, a watermark, etc. In some embodiments, the check template also includes functionality for providing background images, security features, etc.

In some embodiments, generating the Check21-compliant check image 247 at block 824 includes generating the check image directly from the electronic non-DDA transaction information 225, consumer mappings 245, etc. In other embodiments, generating the Check21-compliant check image 247 at block 824 includes printing a physical check instrument. For example, a check image may be generated, printed, then scanned to finally generate the Check21-compliant check image 247. This procedure may be followed to comply with certain regulations, or for other reasons.

In an illustrative embodiment, non-DDA instrument information 215 is extracted from the non-DDA transaction information 225 for each transaction and run through a matching process. The matching process validates the information associated with the transaction. Then, for each valid set of non-DDA transaction information 225 data, the non-DDA instrument information 215 is matched to DDA information according to the consumer mappings 245. The consumer mappings 245 includes data elements utilized to generate a legal check for presentment for settlement (e.g., according to laws and regulations of the U.S. financial system), for example, including the routing and transit number for the bank which holds the consumer's checking account, the consumer's checking account number, the consumer's name, and a check number. In addition, the value of the purchase and the merchant's business name may be used to complete the required elements of the check.

The Check21-compliant check image 247 can then be generated. In one implementation, an ANSI X9.37 file with a check image is created using a standard file format (e.g., TIFF Standard 1992). Alternatively or additionally, a print stream is created by sending the check image to a printer to produce a physical hard copy of the check. It is possible that a single check is printed at a time or that multiple checks are batched together in a single data file before being sent to the printer. The printed check can then be passed through a check scanner and imager, thereby generating (or regenerating) the Check21-compliant check image 247. Some embodiments then proceed in an identical fashion whether or not a printed version of the check was produced.

Having generated the Check21-compliant check image 247, the payment processing entity 240 communicates the check image (e.g., or check image data) to one or more entities for clearing at block 828. In some embodiments, the Check21-compliant check images 247 are electronically (e.g., and securely) routed to a check clearing house (e.g., the Bank of First Deposit and/or other entities), which handles all the clearing, settlement, etc. between consumer banks 260 and merchant banks 270. In certain embodiments, the Check21-compliant check images 247 are routed directly to an appropriate Federal Reserve bank (e.g., a Federal Reserve District Bank). In other embodiments, the payment processing entity 240 performs one or more types of optimization as part of block 828.

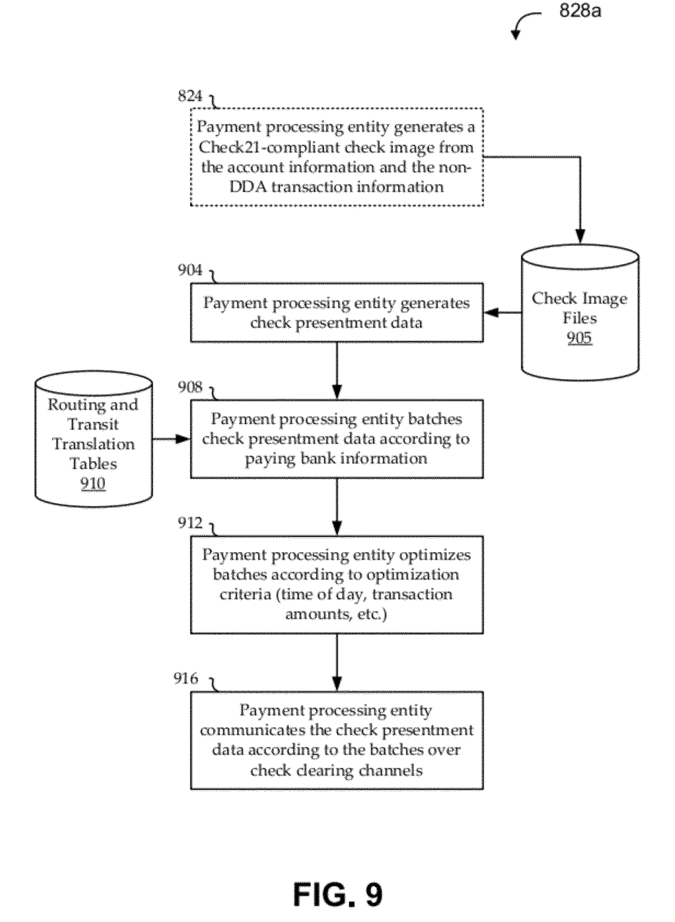

FIG. 9 shows a flow diagram of an illustrative method 828a for communicating the Check21-compliant check images 247 for clearing, according to various embodiments. The method 828a begins at block 824 of FIG. 8 for the sake of context. As described above, the payment processing entity 240 generates Check21-compliant check images 247, which may be stored as check image files 905 (e.g., as an ICL). At block 904, the payment processing entity 240 generates (e.g., extracts, processes, filters, calculates, etc.) check presentment data from the check image files 905.

In some embodiments, various standard (e.g., pre-negotiated and/or regulated) data formats are used for generating check presentment data at block 904. For example, the DSTU X9.37-2003 file format and the X9.100-187-2008 file format can be used. These X9.37 and X9.100-187 file formats are complementary in nature and in the role they play in the industry for check presentment. For example, they define specific sets of data required to present a check for clearing and settlement. Some industry exchanges support the X9.37-2003 format and others support the X9.100-187 format. Accordingly, embodiments may generate either or both data formats (or other formats).

At block 908, the payment processing entity 240 batches the check presentment data according to paying bank information and/or other information. For example, the payment processing entity 240 maintains a database of routing and transit translation tables 910 for use in generating the batches (e.g., sorting the check image files 905) for clearing. In some embodiments, all transactions destined for a particular paying bank are batched into one or more data files (e.g., by matching the bank routing and transit numbers associated with the consumer's DDA account to the database of routing and transit translation tables 910). One or more output data files may be produced as part of block 908 for each particular paying bank or for transaction data for multiple paying banks.

At block 912, the payment processing entity 240 can implement additional optimizations of the batches. For example, different banks may have different times of day at which they clear transaction, different priorities for clearing transactions of different amounts, different data formats used for clearing, different geographical locations (e.g., associations with different Federal Reserve districts), etc. As the transactions are batched for clearing, these factors may be taken into account at block 812. In one illustrative case, transactions are batched for communication at particular times of day according to the times of day associated with the paying banks for those transactions.

Having generated and/or optimized the batches of transaction data (e.g., check presentment data), the payment processing entity 240 communicates the data according to the batches over check clearing channels. For example, the batches of check presentment data are communicated to appropriate Banks of First Deposit via one or more secure network links. As discussed above, the transfer of the check presentment data may occur multiple times each day, periodically, etc.

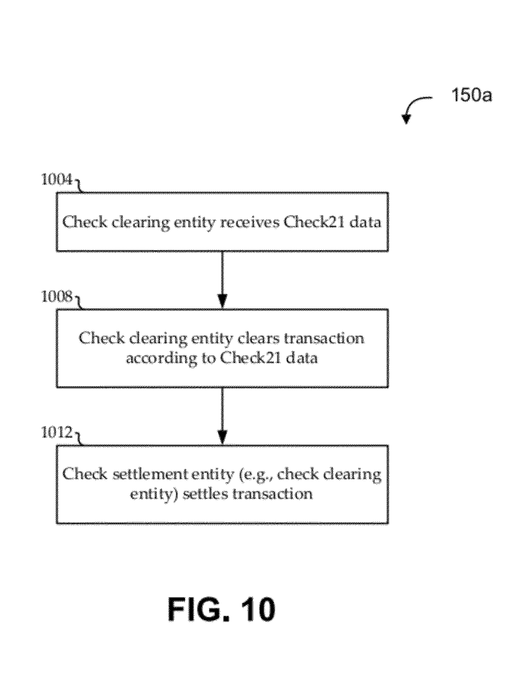

Having converted the non-DDA transaction to a Check21 transaction, the mapping phase 140 can be considered complete, and the clearing phase 150 can begin. FIG. 10 shows a flow diagram of an illustrative clearing phase method 150a, according to various embodiments. The method 150a begins at block 1004, when a check clearing entity receives the check presentment (e.g., Check21 compliant) data.

According to some embodiments, the transaction now appears to the check clearing entity to be a standard Check21 transaction. At block 1008, the check clearing entity clears the transaction according to the check presentment data and according to Check21 and other clearing regulations and procedures. At block 1012, the check clearing entity (e.g., and/or a separate check settlement entity) settles the checking transaction. For example, a debit is made at the consumer bank 260 and a credit is made at the merchant bank 270 according to the transaction (e.g., via respective Federal Reserve District Banks and/or other entities).

In one embodiment, the check presentment data is communicated to a Bank of First Deposit (BOFD) that is the financial institution of the payment processing entity 240. The BOFD initiates the clearing phase 150 for the X9.37/X9.100-187 data files, as discussed above. The BOFD may also reconcile the depositing of funds into the accounts of the payment processing entity 240 when the payments have cleared and are settled. In some embodiments, the depositing of funds is also made to accounts of any payment risk entities.

The BOFD may maintain a secure network connection to multiple presentment points, including a number of check clearing houses that process the X9.37 and X9.100-187 data files. By communicating the data to these clearing houses, the clearing houses can distribute appropriate payment requests to banks with which they maintain a network connection. Typically, these transactions are organized by paying bank and include only “Onus” transactions, namely transactions initiated by account holders maintained by their institution. The BOFD can also route transactions to appropriate Federal Reserve check clearing operations, which accept commingled transaction data files from BOFDs and clear and settle all corresponding transactions.

The BOFD can also maintain network connections to one or more paying banks. These relationships can lower costs and/or expedite funds availability on the clearing and settlement of check clearing transactions. For example, the BOFD sends both check presentment data files having only transactions for the paying bank, and, in some cases, data files that contain comingled transactions for multiple paying banks. Onus transactions may be cleared directly by the paying bank, while comingled transactions may be cleared via correspondent relationships supported by the paying bank or by other clearing and settlement methods (e.g., including distribution to the Federal Reserve).

In some embodiments the bank account of the consumer making the purchase of the good or services will be a different bank from the bank holding the account of the merchant. The resulting clearing and settlement may be according to an “Offus” process. According to the Offus process, the respective bank accounts of the consumer and merchant nay be different and may result in a “net settlement” being performed by the Federal Reserve. Typically, this net settlement occurs overnight, resulting in a “next day” settlement duration.

The various illustrative logical blocks, modules, and circuits described may be implemented or performed with a general purpose processor, a digital signal processor (DSP), an ASIC, a field programmable gate array signal (FPGA), or other programmable logic device (PLD), discrete gate, or transistor logic, discrete hardware components, or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Features implementing functions may also be physically located at various positions, including being distributed such that portions of functions are implemented at different physical locations.

The functions, including steps of a method or algorithm, described in connection with the present disclosure may be implemented in hardware, software, firmware, or any combination thereof. If implemented in software, the functions may be stored as one or more instructions on a tangible computer-readable medium. A storage medium may be any available tangible medium that can be accessed by a computer. By way of example, and not limitation, such computer-readable media can comprise RAM, ROM, EEPROM, CD-ROM, or other optical disk storage, magnetic disk storage, or other magnetic storage devices, or any other tangible medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

The methods disclosed herein comprise one or more actions for achieving the described method. The method and/or actions may be interchanged with one another without departing from the scope of the claims. In other words, unless a specific order of actions is specified, the order and/or use of specific actions may be modified without departing from the scope of the claims.

Thus, a computer program product may perform operations presented herein. For example, such a computer program product may be a computer readable tangible medium having instructions tangibly stored (and/or encoded) thereon, the instructions being executable by one or more processors to perform the operations described herein. The computer program product may include packaging material. Software or instructions may also be transmitted over a transmission medium. For example, software may be transmitted from a website, server, or other remote source using a transmission medium such as a coaxial cable, fiber optic cable, twisted pair, digital subscriber line (DSL), or wireless technology such as infrared, radio, or microwave.

Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C). Further, the term “exemplary” does not mean that the described example is preferred or better than other examples.

Various changes, substitutions, and alterations to the techniques described herein can be made without departing from the technology of the teachings as defined by the appended claims. Moreover, the scope of the disclosure and claims is not limited to the particular aspects of the process, machine, manufacture, composition of matter, means, methods, and actions described above. Processes, machines, manufacture, compositions of matter, means, methods, or actions, presently existing or later to be developed, that perform substantially the same function or achieve substantially the same result as the corresponding aspects described herein may be utilized. Accordingly, the appended claims include within their scope such processes, machines, manufacture, compositions of matter, means, methods, or actions.

What is claimed is:

1. A method comprising:
receiving non-demand deposit account (non-DDA) transaction information at a transaction processing system from a point of sale over a payment network, the non-DDA transaction information corresponding with a transaction between a consumer and the point of sale;
identifying a DDA account with account information associated with the consumer according to a set of consumer mappings maintained by the transaction processing system, the consumer mappings generated as part of a consumer registration process that maps the DDA account of the consumer to a non-DDA transaction instrument; and
generating a Check21-compliant check image from the account information of the DDA account and the non-DDA transaction information.

2. The method of claim 1, wherein the non-DDA transaction information comprises non-DDA instrument information retrieved from the non-DDA transaction instrument during the transaction at the point of sale.

3. The method of claim 2, wherein the non-DDA instrument information comprises debit card information.

4. The method of claim 1, further comprising:
clearing the transaction using the check image according to Check21 clearing channels.

5. The method of claim 4, wherein clearing the transaction comprises:
collecting a plurality of check images from a plurality of transactions over a time period;
collating the plurality of check images into batches according to paying banks associated with the plurality of transactions; and
clearing the check images according to the batches.

6. The method of claim 5, wherein collating the plurality of check images into batches is performed further according to clearing optimization parameters.

7. The method of claim 1, further comprising:
receiving registration information from the consumer comprising the account information of the DDA account associated with the consumer; and
generating and storing the consumer mapping between the registration information and the non-DDA transaction instrument.

8. The method of claim 7, further comprising:
issuing the non-DDA transaction instrument to the consumer as a physical payment instrument having the non-DDA instrument information stored thereon.

9. The method of claim 7, further comprising:
issuing the non-DDA transaction instrument to the consumer as a virtual payment instrument having the non-DDA instrument information stored in a secure database accessible over a network by at least one of the consumer or the point of sale.

10. The method of claim 7, further comprising:
issuing the non-DDA transaction instrument to the consumer as a virtual payment instrument having the non-DDA instrument information stored in a secure location on a mobile device of the consumer.

11. The method of claim 1, wherein generating the Check21-compliant check image from the account information of the DDA account and the non-DDA transaction information comprises:
generating a first electronic image to look like a front side of a check having a plurality of standard check fields filled in according to the account information and the non-DDA transaction information; and
generating a second electronic image to look like a back side of the check.

12. The method of claim 11, further comprising:
determining that at least one of the standard check fields cannot be filled in according to the account information and the non-DDA transaction information; and
filling in the at least one of the standard check fields according to a default value that is not specific to the consumer.

13. The method of claim 1, wherein the non-DDA transaction instrument is a decoupled debit card.

14. The method of claim 1, wherein the point of sale is a virtual point of sale and the payment network comprises the Internet.

15. A transaction processing system in communication with a plurality of points of sale over a payment network, the system comprising:
a mapping subsystem configured to:
receive non-DDA transaction information from one of the points of sale over the payment network, the non-DDA transaction information corresponding with a transaction between a consumer and the point of sale; and
identify a DDA account with account information associated with the consumer according to the non-DDA transaction information using a pre-defined consumer mapping; and
an electronic DDA subsystem, communicatively coupled with the mapping subsystem, and configured to generate a Check21-compliant check image from the DDA account information and the non-DDA transaction information.

16. The system of claim 15, wherein the electronic DDA subsystem is further configured to:
clear the transaction using the check image according to Check21 clearing channels.

17. The system of claim 15, further comprising:
a registration subsystem, communicatively coupled with the mapping subsystem and the electronic DDA subsystem, and configured to:
receive registration information from the consumer comprising the account information of the DDA account associated with the consumer;
generate the mapping between the registration information and non-DDA instrument information; and
store the mapping in a data store.

18. The system of claim 17, further comprising:
a card issuing subsystem configured to issue a non-DDA transaction instrument to the consumer having the non-DDA instrument information stored in relation to the non-DDA transaction instrument.

19. The system of claim 17, wherein the electronic DDA subsystem is configured to generate the Check21-compliant check image from the account information and the debit transaction information by:
printing a check instrument corresponding to a check template, the account information and the non-DDA transaction information; and
scanning the check instrument to generate the Check21-compliant check image.

20. A machine-readable medium having a series of instructions stored thereon, which, when executed by a processor, cause the processor to perform steps comprising:
receiving non-demand deposit account (non-DDA) transaction information from a point of sale over a payment network, the non-DDA transaction information corresponding with a transaction between a consumer and the point of sale;
identifying a DDA account with account information associated with the consumer according to a set of consumer mappings maintained in a data store accessible by the processor and generated as part of a consumer registration process that maps the DDA account of the consumer to non-DDA instrument information; and
generating a Check21-compliant check image from the account information of the DDA account and the non-DDA transaction information.

21. The machine-readable medium of claim 20, wherein the instructions stored thereon, when executed by a processor, cause the processor to perform steps further comprising:
clearing the transaction using the check image according to Check21 clearing channels.

22. The machine-readable medium of claim 20, wherein the instructions stored thereon, when executed by a processor, cause the processor to perform the step of identifying the DDA account according to the set of consumer mappings by:
extracting the non-DDA instrument information from the non-DDA transaction information; and
mapping the non-DDA instrument information to the DDA account according to the set of consumer mappings.
